(19) United States
(12) Patent Application Publication
(10) Pub. No.: US 2014/0111617 A1
(43) Pub. Date: Apr. 24, 2014

(54) OPTICAL SOURCE DRIVER CIRCUIT FOR DEPTH IMAGER

(71) Applicant: LSI CORPORATION, Milpitas, CA (US)

(72) Inventor: Boris Livshitz, Eagan, MN (US)

(73) Assignee: LSI Corporation, Milpitas, CA (US)

(21) Appl. No.: 13/658,153

(22) Filed: Oct. 23, 2012

(51) Int. Cl. H04N 13/02

(52) U.S. Cl. CPC H04N 13/0203
USPC 348/46

(57) ABSTRACT

A depth imager such as a time of flight camera comprises a driver circuit and an optical source. The driver circuit comprises a frequency control module and a controllable oscillator having a control input coupled to an output of the frequency control module. An output of the controllable oscillator is coupled to an input of the optical source, and a driver signal provided by the driver circuit to the optical source utilizing the controllable oscillator varies in frequency under control of the frequency control module in accordance with a designated type of frequency variation, such as a ramped or stepped variation. The driver circuit may additionally or alternatively comprise an amplitude control module, such that a driver signal provided to the optical source varies in amplitude under control of the amplitude control module in accordance with a designated type of amplitude variation.

### BACKGROUND

A number of different techniques are known for generating three-dimensional (3D) images of a spatial scene in real time. For example, 3D images of a spatial scene may be generated using triangulation based on multiple two-dimensional (2D) images. However, a significant drawback of such a technique is that it generally requires very intensive computations, and can therefore consume an excessive amount of the available computational resources of a computer or other processing device. Also, it can be difficult to generate an accurate 3D image under conditions involving insufficient ambient lighting when using such a technique.

Other known techniques include directly generating a 3D image using a depth imager such as a time of flight (ToF) camera. ToF cameras are usually compact, provide rapid image generation, and operate in the near-infrared part of the electromagnetic spectrum. As a result, ToF cameras are commonly used in machine vision applications such as gesture recognition in video gaming systems or other types of image processing systems implementing gesture-based human-machine interfaces. ToF cameras are also utilized in a wide variety of other machine vision applications, including, for example, face detection and singular or multiple person tracking.

A typical conventional ToF camera includes an optical source comprising, for example, one or more light-emitting diodes (LEDs) or laser diodes. Each such LED or laser diode is controlled to produce continuous wave (CW) output light having substantially constant frequency and amplitude. The output light illuminates a scene to be imaged and is scattered or reflected by objects in the scene. The resulting return light is detected and utilized to create a depth map or other type of 3D image. This more particularly involves, for example, utilizing phase differences between the output light and the return light to determine distances to the objects in the scene. Also, the amplitude of the return light is used to determine intensity levels for the image.

However, the use of CW output light in a ToF camera has a number of significant drawbacks. For example, the frequency of the CW output light unduly restricts the maximum unambiguous range of the camera. More particularly, the maximum unambiguous range is generally given by c/2f, where f is the frequency of the CW output light and c is the speed of light. The maximum unambiguous range can be extended by decreasing the frequency f, but this approach also decreases the measurement precision.

In addition, when utilizing CW output light, image quality degrades as the length of an integration time window is decreased. As a result, a ToF camera often cannot support a frame rate that is sufficiently high to track dynamic objects in the scene. On the other hand, saturation of image pixels is observed as the length of the integration time window is increased. Conventional ToF cameras based on CW light are generally unable to provide suitable optimization of the integration time window.

### SUMMARY

Embodiments of the invention provide, by way of example, optical source driver circuits for ToF cameras and other types of depth imagers.

In one embodiment, a depth imager comprises a driver circuit and an optical source. The driver circuit comprises a frequency control module and a controllable oscillator having a control input coupled to an output of the frequency control module. An output of the controllable oscillator is coupled to an input of the optical source, and a driver signal provided by the driver circuit to the optical source utilizing the controllable oscillator varies in frequency under control of the frequency control module in accordance with a designated type of frequency variation, such as a ramped or stepped frequency variation.

The driver circuit in a given embodiment may additionally or alternatively comprise an amplitude control module, such that a driver signal provided to the optical source varies in amplitude under control of the amplitude control module in accordance with a designated type of amplitude variation, such as a ramped or stepped amplitude variation.

Other embodiments of the invention include but are not limited to methods, systems, integrated circuits, and computer-readable media storing program code which when executed causes a processing device to execute a sequence of steps.

### BRIEF DESCRIPTION OF THE DRAWINGS

FIG. 1 is a block diagram of an image processing system comprising a depth imager that includes an optical source driver circuit in one embodiment.

FIG. 2 shows an embodiment of a portion of a depth imager comprising an optical source and an associated driver circuit implementing ramp-based frequency and amplitude control modules.

FIG. 3 shows another embodiment of a portion of a depth imager comprising an optical source and an associated driver circuit implementing step-based frequency and amplitude control modules.

FIG. 4A illustrates an exemplary driver signal with ramped frequency and amplitude generated by the driver circuit of FIG. 2.

FIG. 4B illustrates an exemplary driver signal with stepped frequency and amplitude generated by the driver circuit of FIG. 3.

FIG. 5 is a plot showing input-output response of the optical source of FIG. 2 responsive to application of the drive signal of FIG. 4A.

### DETAILED DESCRIPTION

Embodiments of the invention will be illustrated herein in conjunction with exemplary image processing systems that include depth imagers having optical source driver circuits configured to provide at least one of frequency variation and amplitude variation in a given optical source driver signal. It should be understood, however, that embodiments of the invention are more generally applicable to any image processing system or associated depth imager in which it is desirable to provide improved quality for depth maps or other types of 3D images.

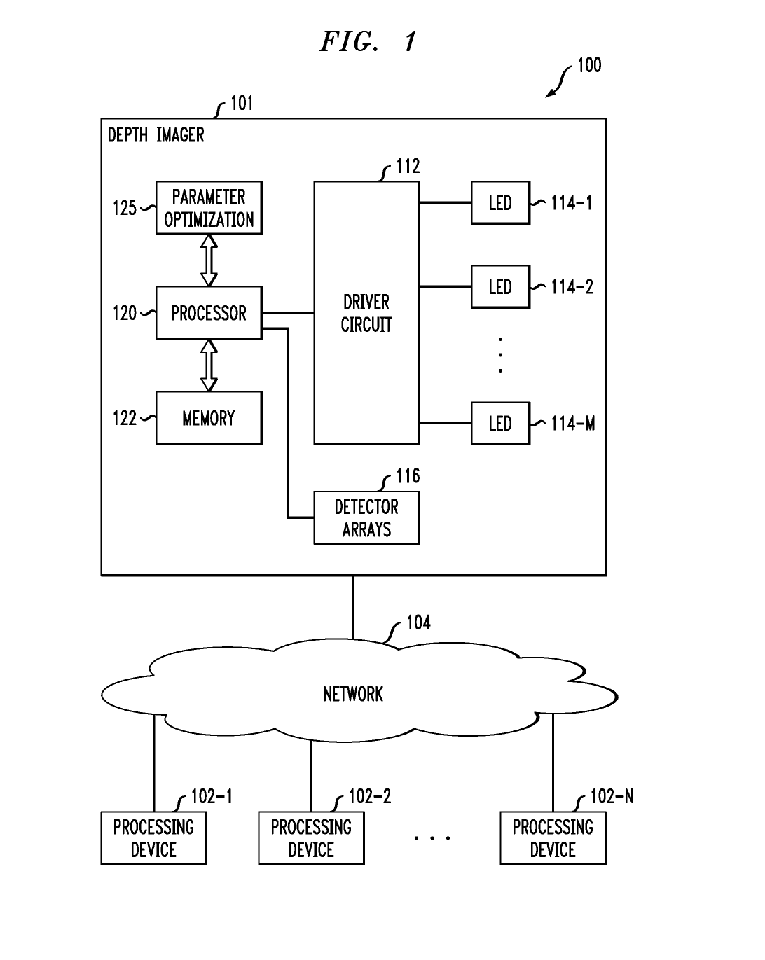

FIG. 1 shows an image processing system 100 in an embodiment of the invention. The image processing system 100 comprises a depth imager 101 that communicates with a plurality of processing devices 102-1, 102-2, . . . 102-N, over a network 104. The depth imager 101 in the present embodiment is assumed to comprise a 3D imager such as a ToF camera, although other types of depth imagers may be used in other embodiments. Such an imager generates depth maps or other depth images of a scene and communicates those images over network 104 to one or more of the processing devices 102. Thus, the processing devices 102 may comprise computers, servers or storage devices, in any combination. One or more such devices also may include, for example, display screens or other user interfaces that are utilized to present images generated by the depth imager 101.

Although shown as being separate from the processing devices 102 in the present embodiment, the depth imager 101 may be at least partially combined with one or more of the processing devices. Thus, for example, the depth imager 101 may be implemented at least in part using a given one of the processing devices 102. By way of example, a computer may be configured to incorporate depth imager 101.

In a given embodiment, the image processing system 100 is implemented as a video gaming system or other type of gesture-based system that generates images in order to recognize user gestures. The disclosed imaging techniques can be similarly adapted for use in a wide variety of other systems requiring a gesture-based human-machine interface, and can also be applied to numerous applications other than gesture recognition, such as machine vision systems involving face detection, person tracking or other techniques that process depth images from a depth imager.

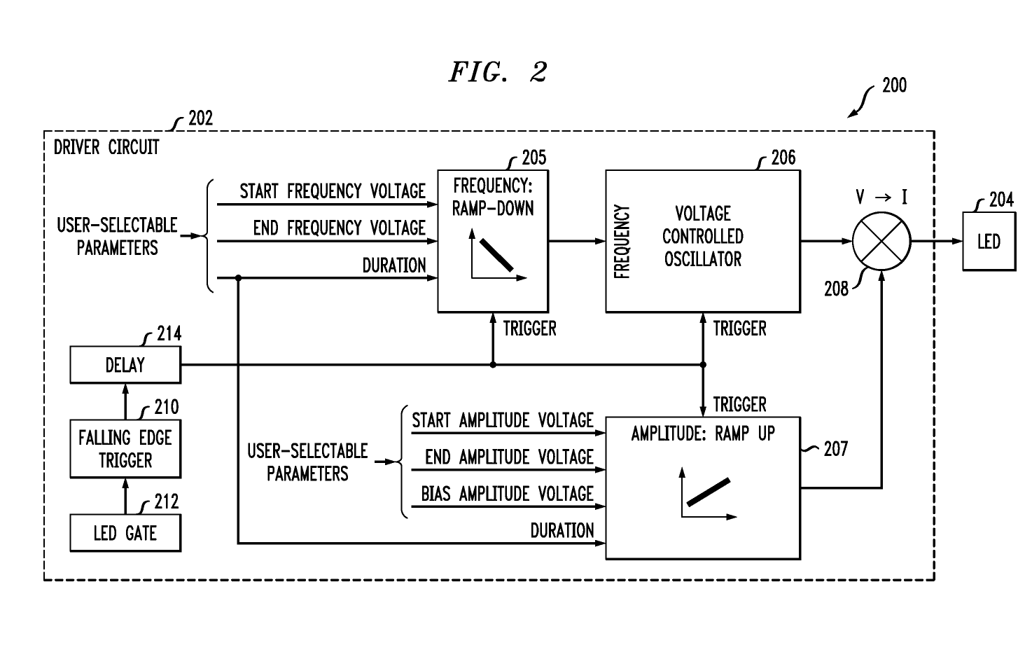

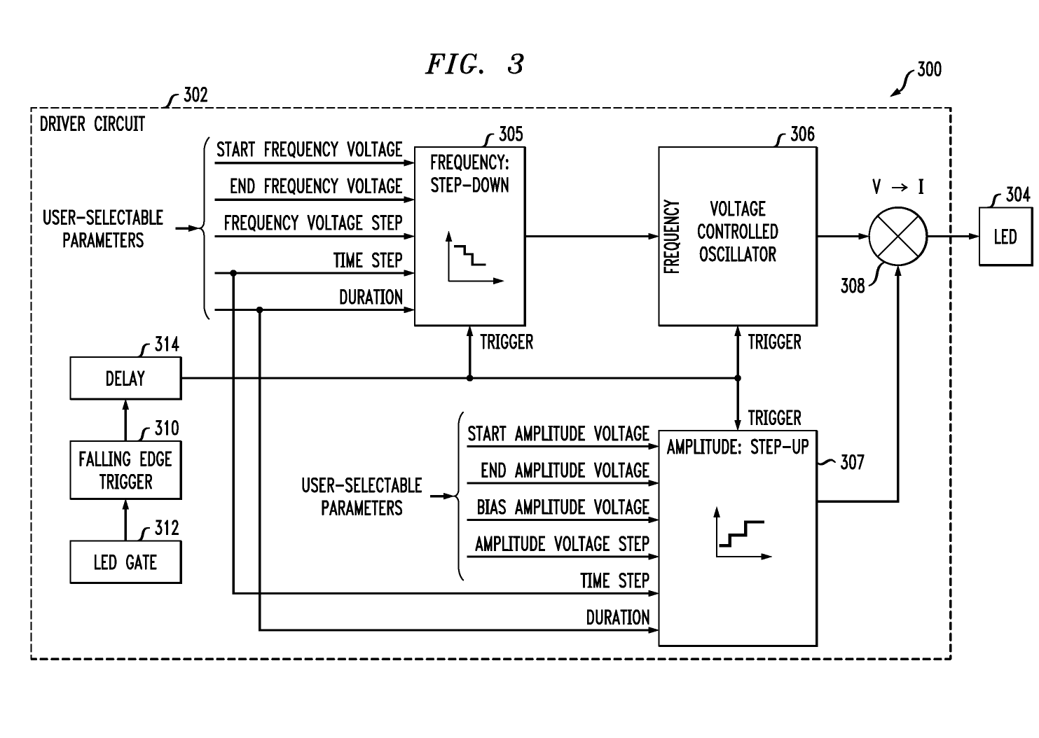

The depth imager 101 as shown in FIG. 1 comprises a driver circuit 112 coupled to a plurality of optical sources 114-1, 114-2, . . . 114-M, illustratively implemented as respective LEDs, which may be arranged in an LED array. Although multiple optical sources are used in this embodiment, other embodiments may include only a single optical source. Also, although a single driver circuit 112 drives all of the optical sources 114 in this embodiment, in other embodiments each of the optical sources 114 may be driven by a separate driver circuit 112. It is to be appreciated that optical sources other than LEDs may be used. For example, at least a portion of the LEDs 114 may be replaced with laser diodes or other optical sources in other embodiments. More detailed examples of the driver circuit 112 will be described below in conjunction with FIGS. 2 and 3.

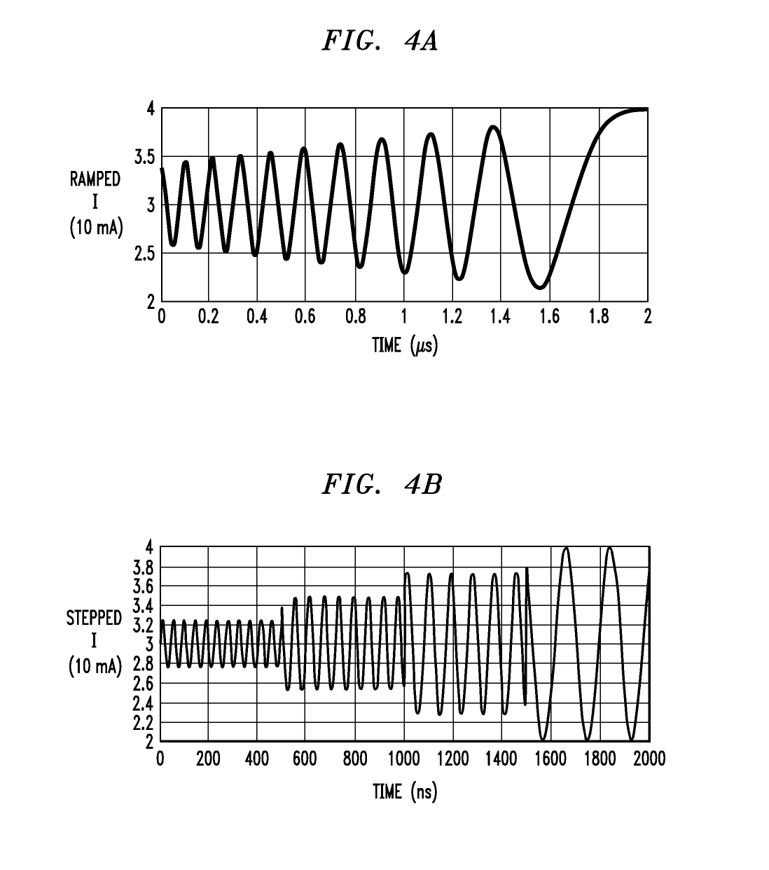

The driver circuit 112 controls the LEDs 114 so as to generate output light having particular frequency and amplitude variations. Ramped and stepped examples of such variations provided by the driver circuit 112 can be seen in FIGS. 4A and 4B, respectively. The output light illuminates a scene to be imaged and the resulting return light is detected using detector arrays 116 and then further processed in depth imager 101 to create a depth map or other type of 3D image.

The driver circuit 112 in a given embodiment may comprise a frequency control module, such that a driver signal provided to at least one of the LEDs 114 varies in frequency under control of the frequency control module in accordance with a designated type of frequency variation, such as a ramped or stepped frequency variation.

The ramped or stepped frequency variation can be configured to provide, for example, an increasing frequency as a function of time, a decreasing frequency as a function of time, or combinations of increasing and decreasing frequency. Also, the increasing or decreasing frequency may follow a linear function or a non-linear function, or combinations of linear and non-linear functions.

In an embodiment with ramped frequency variation, a frequency control module implemented in the driver circuit may be configured to permit user selection of one or more parameters of the ramped frequency variation including one or more of a start frequency, an end frequency and a duration for the ramped frequency variation.

Similarly, in an embodiment with stepped frequency variation, the frequency control module may be configured to permit user selection of one or more parameters of the stepped frequency variation including one or more of a start frequency, an end frequency, a frequency step size, a time step size and a duration for the stepped frequency variation.

The driver circuit 112 in a given embodiment may additionally or alternatively comprise an amplitude control module, such that a driver signal provided to at least one of the LEDs 114 varies in amplitude under control of the amplitude control module in accordance with a designated type of amplitude variation, such as a ramped or stepped amplitude variation. Like the ramped or stepped frequency variations noted above, the ramped or stepped amplitude variation can be configured to provide an increasing amplitude as a function of time, a decreasing amplitude as a function of time, or combinations of increasing and decreasing amplitude. Also, the increasing or decreasing amplitude may follow a linear function or a non-linear function, or combinations of linear and non-linear functions. Moreover, the amplitude variations may be synchronized with the frequency variations if the embodiment includes both an amplitude control module and a frequency control module.

In an embodiment with ramped amplitude variation, the amplitude control module may be configured to permit user selection of one or more parameters of the ramped amplitude variation including one or more of a start amplitude, an end amplitude, a bias amplitude and a duration for the ramped amplitude variation.

Similarly, in an embodiment with stepped amplitude variation, the amplitude control module may be configured to permit user selection of one or more parameters of the stepped amplitude variation including a one or more of a start amplitude, an end amplitude, a bias amplitude, an amplitude step size, a time step size and a duration for the stepped amplitude variation.

The driver circuit 112 can therefore be configured to generate driver signals having designated types of frequency and amplitude variations, in a manner that provides significantly improved performance in depth imager 101 relative to conventional depth imagers. For example, such an arrangement may be configured to allow particularly efficient optimization of not only driver signal frequency and amplitude, but also other parameters such as an integration time window.

The depth imager 101 in the present embodiment is assumed to be implemented using at least one processing device and comprises a processor 112 coupled to a memory 122. The processor 120 controls the driver circuit 112 and detector arrays 116 using software code stored in memory 122.

The processor 120 may comprise, for example, a microprocessor, an application-specific integrated circuit (ASIC), a field-programmable gate array (FPGA), a central processing unit (CPU), an arithmetic logic unit (ALU), a digital signal processor (DSP), or other similar processing device component, as well as other types and arrangements of image processing circuitry, in any combination.

The memory 122 stores software code for execution by the processor 120 in implementing portions of the functionality of depth imager 101, such as portions of the frequency and amplitude control modules described previously. A given such memory that stores software code for execution by a corresponding processor is an example of what is more generally referred to herein as a computer-readable medium or other type of computer program product having computer program code embodied therein, and may comprise, for example, electronic memory such as random access memory (RAM) or read-only memory (ROM), magnetic memory, optical memory, or other types of storage devices in any combination. As indicated above, the processor may comprise portions or combinations of a microprocessor, ASIC, FPGA, CPU, ALU, DSP or other image processing circuitry.

Also included in the depth imager 101 in the present embodiment is a parameter optimization module 125 that is illustratively configured to optimize the integration time window of the depth imager as well as optimization of the frequency and amplitude variations for a given imaging operation. For example, the parameter optimization module 125 may be configured to determine an appropriate set of parameters including integration time window, frequency variation and amplitude variation for the given imaging operation.

Such an arrangement allows the depth imager to be configured for optimal performance under a wide variety of different operating conditions, such as distance to objects in the scene, number and type of objects in the scene, and so on. Thus, for example, integration time window length of the depth imager 101 in the present embodiment can be determined in conjunction with selection of driver signal frequency and amplitude variations in a manner that optimizes overall performance under particular conditions. The parameter optimization module 125 may be implemented at least in part in the form of software stored in memory 122 and executed by processor 120. It should be noted that terms such as “optimal” and “optimization” as used in this context are intended to be broadly construed, and do not require minimization or maximization of any particular performance measure.

The network 104 may comprise a wide area network (WAN) such as the Internet, a local area network (LAN), a cellular network, or any other type of network, as well as combinations of multiple networks. The depth imager 101 and each of the processing devices 102 may incorporate transceivers or other network interface circuitry to allow these devices to communicate with one another over the network 104.

It should also be appreciated that embodiments of the invention may be implemented in the form of integrated circuits. In a given such integrated circuit implementation, identical die are typically formed in a repeated pattern on a surface of a semiconductor wafer. Each die includes at least one driver circuit and possibly other image processing circuitry as described herein, and may further include other structures or circuits. The individual die are cut or diced from the wafer, then packaged as an integrated circuit. One skilled in the art would know how to dice wafers and package die to produce integrated circuits. Integrated circuits so manufactured are considered embodiments of the invention.

The particular configuration of image processing system 100 as shown in FIG. 1 is exemplary only, and the system 100 in other embodiments may include other elements in addition to or in place of those specifically shown, including one or more elements of a type commonly found in a conventional implementation of such a system.

FIG. 2 shows an embodiment of a portion 200 of a depth imager comprising an optical source 204, illustratively implemented as an LED, and an associated driver circuit 202 configured to provide synchronized ramp-based frequency and amplitude variations in imager output light emitted by the optical source 204. The driver circuit 202 in this embodiment comprises a frequency control module 205, a voltage controlled oscillator 206 and an amplitude control module 207. The voltage controlled oscillator 206 has a control input coupled to an output of the frequency control module 206 and its output is coupled to an input of the optical source 204 via a mixer 208.

The mixer 208 more particularly has a first input coupled to the output of the voltage controlled oscillator 206, a second input coupled to an output of the amplitude control module 207, and an output providing the driver signal for the optical source 204. In this embodiment, the mixer 208 serves to provide a single driver signal that combines the amplitude variations exhibited by an output signal of the amplitude control module 207 with the frequency variations exhibited by an output signal of the voltage controlled oscillator 206. In generating the driver signal, which is illustratively a current signal in the present embodiment, the mixer 208 performs a voltage to current (V→I) conversion.

Although a voltage controlled oscillator 206 is utilized in driver circuit 202 in the present embodiment, other embodiments can utilize other types of oscillators, such as, for example, numerically controlled oscillators.

The driver circuit 202 is configured to generate a driver signal for application to the optical source 204 utilizing the voltage controlled oscillator 206. The frequency and amplitude of the driver signal are controlled by the respective frequency control and amplitude control modules 205 and 207 such that the driver signal exhibits designated types of frequency and amplitude variation.

The designated type of frequency variation in the present embodiment comprises a ramped frequency variation providing a decreasing frequency as a function of time. This is also referred to in the figure as a “ramp-down” frequency variation. The frequency control module 205 is configured to permit user selection of designated parameters of the ramped frequency variation, including in this embodiment a start frequency, an end frequency and a duration for the ramped frequency variation. The start and end frequencies are specified using corresponding input voltages in this embodiment.

It should be noted that the term “user” in this context is intended to be broadly construed, so as to encompass not only human users but also other types of users, including automated software or hardware entities of the image processing system that utilize the depth imager 101 to generate depth images of scenes. Thus, for example, a software program or other type of agent running on or otherwise associated with one of the processing devices 102 may be configured to interact with driver circuit 202 so as to select one or more parameters of at least one of a frequency variation provided by the frequency control module 205 and an amplitude variation provided by the amplitude control module 207.

The designated type of amplitude variation in the present embodiment comprises a ramped amplitude variation providing an increasing amplitude as a function of time. This is also referred to in the figure as a “ramp-up” amplitude variation. The amplitude control module 207 is configured to permit user selection of designated parameters of the ramped amplitude variation, including in this embodiment a start amplitude, an end amplitude, a bias amplitude and a duration for the ramped amplitude variation. The start, end and bias amplitudes are specified using corresponding input voltages in this embodiment. These amplitude parameters should be selected so as to be above a threshold current level of the optical source 204.

FIG. 4A shows an example of a driver signal with synchronized decreasing frequency and increasing amplitude as generated by the driver circuit 202. The plot may be viewed as showing the current driver signal at the output of the mixer 208, and illustrates current variation in tens of milliamps (mA) as a function of time in microseconds (μs). This current driver signal is applied to an input of the optical source 204. Using a frequency range of 10-50 MHz, the period of the current driver signal is in the range of 20-100 nanoseconds, which in a given embodiment can provide a maximum unambiguous range of between about 6 meters and 30 meters for the depth imager. In other embodiments, a wide variety of alternative frequency ranges, maximum unambiguous ranges and other parameters may be used.

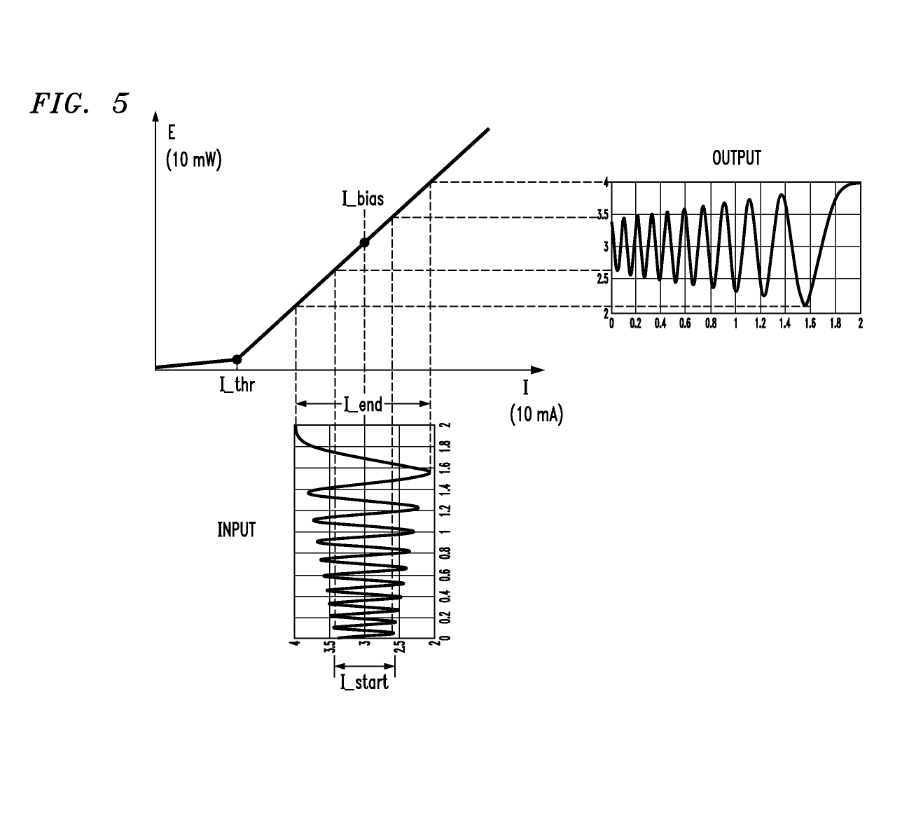

The corresponding input-output response of the optical source 204 is shown in FIG. 5, illustrating that the frequency and amplitude variations of the applied current driver signal are reproduced in output light variations of the optical source. The input-output response in this example is plotted as LED output power E in milliwatts (mW) as a function of drive current in tens of milliamps (mA). The drive current varies about a bias current denoted as I_bias, and the LED is assumed to be operated in a substantially linear portion of its input-output response above a threshold current denoted I_thr.

In other embodiments, other combinations of increasing or decreasing frequency and amplitude variations may be used. Also, although the frequency and amplitude variations are in the form of substantially linear ramps in this embodiment, other embodiments can utilize variations that follow non-linear functions, or multiple linear and non-linear functions, in any combination.

The driver circuit 202 synchronizes the frequency and amplitude variations by utilizing a common trigger signal for the frequency control module 205, voltage controlled oscillator 206 and amplitude control module 207. The trigger signal is generated by a falling edge trigger circuit 210 responsive to a signal provided by a gating circuit 212 illustratively implemented as an LED gate. The trigger signal may be a pulse signal having a designated pulse width. Although the trigger signal is falling edge triggered in this embodiment, other types of trigger circuitry and resulting trigger signals may be used.

The gating circuit 212 generates its output signal for application to an input of the trigger circuit 210 responsive to a gate voltage or other optical source control signal which may be provided by the processor 120 of depth imager 101. The trigger signal generated by trigger circuit 210 is subject to a predetermined delay in delay circuit 214 before being applied to respective trigger inputs of the frequency control module 205, the voltage controlled oscillator 206 and the amplitude control module 207. The predetermined delay in the present embodiment is an amount of delay that will allow the voltage controlled oscillator 206 to reach a stable output condition after being powered on.

Referring now to FIG. 3, another embodiment of a portion 300 of a depth imager is shown, comprising an optical source 304, illustratively implemented as an LED, and an associated driver circuit 302 configured to provide synchronized step-based frequency and amplitude variations in imager output light emitted by the optical source 304. The operation of the driver circuit 302 is generally similar to that of driver circuit 202 previously described in conjunction with FIG. 2, but provides step-based frequency and amplitude variations instead of ramp-based frequency and amplitude variations.

The driver circuit 302 in this embodiment comprises a frequency control module 305, a voltage controlled oscillator 306 and an amplitude control module 307. The voltage controlled oscillator 306 has a control input coupled to an output of the frequency control module 306 and its output is coupled to an input of the optical source 304 via a mixer 308. The mixer 308 more particularly has a first input coupled to the output of the voltage controlled oscillator 306, a second input coupled to an output of the amplitude control module 307, and an output providing the driver signal for the optical source 304.

Again, although a voltage controlled oscillator 306 is utilized in driver circuit 302 in the present embodiment, other embodiments can utilize other types of oscillators, such as, for example, numerically controlled oscillators.

The driver circuit 302 is configured to generate a driver signal for application to the optical source 304 utilizing the voltage controlled oscillator 306. The frequency and amplitude of the driver signal are controlled by the respective frequency control and amplitude control modules 305 and 307 such that the driver signal exhibits designated types of frequency and amplitude variation.

The designated type of frequency variation in the present embodiment comprises a stepped frequency variation providing a decreasing frequency that follows downward steps as a function of time. This is also referred to in the figure as a “step-down” frequency variation. The frequency control module 305 is configured to permit user selection of designated parameters of the stepped frequency variation, including in this embodiment a start frequency, an end frequency, a frequency step size, a time step size and a duration for the stepped frequency variation.

The designated type of amplitude variation in the present embodiment comprises a stepped amplitude variation providing an increasing amplitude that follows upward steps as a function of time. This is also referred to in the figure as a “step-up” amplitude variation. The amplitude control module 307 is configured to permit user selection of designated parameters of the stepped amplitude variation, including in this embodiment a start amplitude, an end amplitude, a bias amplitude, an amplitude step size, a time step size and a duration for the stepped amplitude variation.

FIG. 4B shows an example of a driver signal with synchronized decreasing frequency and increasing amplitude as generated by the driver circuit 302. The plot may be viewed as showing the current driver signal at the output of the mixer 308, and illustrates current variation in tens of milliamps (mA) as a function of time in nanoseconds (ns). In each step, different frequency and amplitude values are used for the current driver signal. This current driver signal is applied to an input of the optical source 304, such that the frequency and amplitude variations of the applied current driver signal are reproduced in output light variations of the optical source.

Again, in other embodiments, other combinations of increasing or decreasing frequency and amplitude variations may be used. Also, although the frequency and amplitude variations are in the form of substantially uniform steps in this embodiment, other embodiments can utilize variations that follow non-linear functions, or multiple linear and non-linear functions, in any combination.

As in the FIG. 2 embodiment, the driver circuit 302 synchronizes the frequency and amplitude variations by utilizing a common trigger signal for the frequency control module 305, voltage controlled oscillator 306 and amplitude control module 307. The trigger signal is generated by a falling edge trigger circuit 310 responsive to a signal provided by a gating circuit 312 illustratively implemented as an LED gate. The gating circuit 312 generates its output signal for application to an input of the trigger circuit 310 responsive to an optical source control signal which may be provided by the processor 120 of depth imager 101. The trigger signal output of trigger circuit 310 is subject to a predetermined delay in delay circuit 314 before being applied to respective trigger inputs of the frequency control module 305, the voltage controlled oscillator 306 and the amplitude control module 307. The predetermined delay in the present embodiment is an amount that will allow the voltage controlled oscillator 306 to reach a stable output condition.

The synchronized frequency and amplitude variations in the driver signals provided by driver circuits 202 and 302 in the embodiments of FIGS. 2 and 3 can significantly improve the performance of depth imagers such as ToF cameras. For example, such variations can extend the unambiguous range of the depth imager 101 without adversely impacting measurement precision, at least in part because the frequency variations permit superimposing of detected depth information for each frequency. Also, a substantially higher frame rate can be supported than would otherwise be possible using conventional CW output light arrangements, at least in part because the amplitude variations allow the integration time window to be adjusted dynamically to optimize performance of the depth imager, thereby providing improved tracking of dynamic objects in a scene. The amplitude variations also result in better reflection from objects in the scene, further improving depth image quality.

In the FIG. 2 and FIG. 3 embodiments, the frequency variations are synchronized with the amplitude variations. However, other embodiments may utilize only frequency variations or only amplitude variations. For example, use of ramped or stepped frequency with constant amplitude may be beneficial in cases in which the scene to be imaged comprises multiple objects located at different distances from the depth imager.

As another example, use of ramped or stepped amplitude with constant frequency may be beneficial in cases in which the scene to be imaged comprises a single primary object that is moving either toward or away from the depth imager, or moving from a periphery of the scene to a center of the scene or vice versa. In such arrangements, a decreasing amplitude driver signal is expected to be well suited for cases in which the primary object is moving toward the depth imager or from the periphery to the center, and an increasing amplitude driver signal is expected to be well suited for cases in which the primary object is moving away from the depth imager or from the center to the periphery. Similar considerations may be used in selecting the type of amplitude variation to be applied in embodiments that include both frequency and amplitude variations.

As noted above, a wide variety of different types and combinations of frequency and amplitude variations may be used in other embodiments, including variations following linear, exponential, quadratic or arbitrary functions.

It is to be appreciated that the particular driver circuitry arrangements, driver signals and output light waveforms shown in FIGS. 2 through 5 are presented by way of example only, and other embodiments of the invention may utilize other types and arrangements of elements for implementing a driver circuit for an optical source in a ToF camera or other type of depth imager.

Also, numerous other types of control modules may be used to establish different frequency and amplitude variations for a given driver signal waveform. For example, static frequency and amplitude control modules may be used, in which the respective frequency and amplitude variations are not dynamically variable by user selection in conjunction with operation of the depth imager but are instead fixed to particular configurations by design. Thus, for example, a particular type of frequency variation and a particular type of amplitude variation may be predetermined during a design phase and those predetermined variations may be made fixed rather than variable in the depth imager. Static circuitry arrangements of this type providing at least one of frequency variation and amplitude variation for an optical source driver signal are considered examples of “control modules” as that term is broadly utilized herein, and are distinct from conventional arrangements such as ToF cameras that generally utilize CW output light having substantially constant frequency and amplitude.

It should again be emphasized that the embodiments of the invention as described herein are intended to be illustrative only. For example, other embodiments of the invention can be implemented utilizing a wide variety of different types and arrangements of image processing systems, depth imagers, image processing circuitry, driver circuits, control modules, processing devices and processing operations than those utilized in the particular embodiments described herein. In addition, the particular assumptions made herein in the context of describing certain embodiments need not apply in other embodiments. These and numerous other alternative embodiments within the scope of the following claims will be readily apparent to those skilled in the art.

What is claimed is:

1. An apparatus comprising:
a depth imager comprising a driver circuit and an optical source;
the driver circuit comprising:
a frequency control module; and
a controllable oscillator having a control input coupled to an output of the frequency control module;
wherein an output of the controllable oscillator is coupled to an input of the optical source; and
wherein a driver signal provided by the driver circuit to the optical source utilizing the controllable oscillator varies in frequency under control of the frequency control module in accordance with a designated type of frequency variation.

2. The apparatus of claim 1 wherein the driver circuit further comprises an amplitude control module.

3. The apparatus of claim 1 wherein the driver signal provided by the driver circuit to the optical source utilizing the controllable oscillator also varies in amplitude under control of the amplitude control module in accordance with a designated type of amplitude variation.

4. The apparatus of claim 2 wherein the driver circuit further comprises a mixer circuit having a first input coupled to the output of the controllable oscillator, a second input coupled to an output of the amplitude control module, and an output providing the driver signal for the optical source.

5. The apparatus of claim 1 wherein the controllable oscillator comprises one of a voltage controlled oscillator and a numerically controlled oscillator.

6. The apparatus of claim 1 wherein the designated type of frequency variation comprises one of a ramped frequency variation and a stepped frequency variation, said ramped or stepped frequency variation providing one of an increasing frequency as a function of time and a decreasing frequency as a function of time, and wherein said increasing or decreasing frequency follows one of a linear function and a non-linear function.

7. The apparatus of claim 6 wherein the frequency control module is configured to permit user selection of one or more parameters of the ramped frequency variation including one or more of a start frequency, an end frequency and a duration for the ramped frequency variation.

8. The apparatus of claim 6 wherein the frequency control module is configured to permit user selection of one or more parameters of the stepped frequency variation including one or more of a start frequency, an end frequency, a frequency step size, a time step size and a duration for the stepped frequency variation.

9. The apparatus of claim 3 wherein the designated type of amplitude variation comprises one of a ramped amplitude variation and a stepped amplitude variation, said ramped or stepped amplitude variation providing one of an increasing amplitude as a function of time and a decreasing amplitude as a function of time, and wherein said increasing or decreasing amplitude follows one of a linear function and a non-linear function.

10. The apparatus of claim 9 wherein the amplitude control module is configured to permit user selection of one or more parameters of the ramped amplitude variation including one or more of a start amplitude, an end amplitude, a bias amplitude and a duration for the ramped amplitude variation.

11. The apparatus of claim 9 wherein the amplitude control module is configured to permit user selection of one or more parameters of the stepped amplitude variation including a one or more of a start amplitude, an end amplitude, a bias amplitude, an amplitude step size, a time step size and a duration for the stepped amplitude variation.

12. The apparatus of claim 1 wherein the driver circuit further comprises a trigger circuit configured to generate a trigger signal for application to respective trigger inputs of the frequency control module and the controllable oscillator.

13. The apparatus of claim 12 wherein the driver circuit further comprises an amplitude control module and the trigger signal from the trigger circuit is also applied to a trigger input of the amplitude control module.

14. The apparatus of claim 12 wherein the driver circuit further comprises:
a gating circuit configured to control generation of the trigger signal by the trigger circuit responsive to an optical source control signal; and
a delay circuit coupled between the trigger circuit and the trigger inputs of the frequency control module and the controllable oscillator.

15. The apparatus of claim 1 further comprising a parameter optimization module associated with the driver circuit and configured to optimize an integration time window of the depth imager for a given imaging operation.

16. The apparatus of claim 1 wherein the depth imager comprises a time of flight camera.

17. The apparatus of claim 1 wherein the optical source comprises one of a light-emitting diode and a laser diode.

18. An image processing system comprising the apparatus of claim 1.

19. The image processing system of claim 18 wherein the system implements one or more machine vision applications utilizing the depth imager including one or more of gesture recognition, face detection and person tracking.

20. A method comprising:
generating a driver signal for application to an optical source in a depth imager; and
controlling at least one of a frequency and an amplitude of the driver signal such that the driver signal varies in accordance with at least one of a designated type of frequency variation and a designated type of amplitude variation.

21. The method of claim 20 wherein said designated type of frequency or amplitude variation comprises one of a ramped variation and a stepped variation.

22. A computer-readable storage medium having computer program code embodied therein, wherein the computer program code when executed in the depth imager causes the depth imager to perform the method of claim 20.

23. An apparatus comprising:
a driver circuit adapted for coupling to an optical source of a depth imager;
the driver circuit comprising:
at least one of a frequency control module and an amplitude control module; and
an oscillator;
wherein the driver circuit is configured to generate a driver signal for application to the optical source utilizing the oscillator; and
wherein at least one of a frequency and an amplitude of the driver signal is controlled by a corresponding one of the respective frequency control and amplitude control modules such that the driver signal varies in accordance with at least one of a designated type of frequency variation and a designated type of amplitude variation.

24. An integrated circuit comprising the apparatus of claim 23.
